(19) United States
(12) Patent Application Publication
(10) Pub. No.: US 2008/0030564 A1
(43) Pub. Date: Feb. 7, 2008

(54) Methods and Apparatuses for Printing on Ribbon Using Hand-held Printer

(76) Inventors: Adam Jude Ahne, Carbondale, IL (US); Edmund Hulin James, Lexington, KY (US); Mark Aaron Neal, Lexington, KY (US); Sarah Marie Springer, Lexington, KY (US); Randal Scott Williamson, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/461,841

(22) Filed: Aug. 2, 2006

(51) Int. Cl. B41J 3/36

(52) U.S. Cl. 347/109

(57) ABSTRACT

Handheld printers and methods of printing receive a first portion of a material underneath at least one print nozzle. At least a second portion of the material is mounted on a spool. The rotation of the spool is detected using an optical sensor. At least one print nozzle is instructed to eject ink onto the first portion of the material based, at least in part, on the detection of the rotation of the spool using the optical sensor.

### FIELD OF THE INVENTION

The present invention relates generally to handheld printers, and more particularly, to systems, methods and apparatuses for printing on a thin strip of material, such as a ribbon using a hand-held printer.

### BACKGROUND OF THE INVENTION

Portable computer printers are well known in the prior art and include dot-matrix printers, piezo-electric ink jet printers, laser printers and thermal ink jet printers. When using handheld printers the printing surface is not fed through printer, but rather the handheld printer is placed on a printing surface.

On many handheld printers, printing is started and stopped through the depression of a “print” button. The printer head is first applied to the desired printing surface where the user wants printing to commence. The handheld printer is generally aligned with the printing surface in a fashion so that the image may be linearly printed across the surface. The user next presses the button to initiate the printer head to begin printing the desired image onto the printing surface. This process continues for as long as the user depresses the print button or until an image to be printed is complete.

Notwithstanding that handheld printers permit the flexibility of printing on almost any continuous, print-friendly surface selected by a user, there is nothing that permits a user of a handheld printer to accurately print on a narrow surface while positioning the printer by hand. Therefore, handheld printers are not adept at printing on narrow media, such as small pieces of material including ribbons, strips of fabric, strips of paper, and the like.

Therefore, what is needed are methods and apparatuses for enabling a handheld printer to print on narrow pieces of material accurately.

### BRIEF SUMMARY OF THE INVENTION

According to an embodiment of the invention, there is disclosed a handheld printer. The printer includes at least one print nozzle, and an optical sensor, where the optical sensor is operable to detect the rotation of a spool engaging the handheld printer. The printer also includes at least one print management module, operable to instruct the at least one print nozzle to eject ink onto a first portion of a material responsive to the optical sensor detecting the rotation of the spool.

According to an aspect of the invention, the at least one print management module includes a processor, an application specific integrated chip, or computer-executable program code. According to another aspect of the invention, the printer includes a tracking roller coupled to the spool, where the optical sensor detects movement of the tracking roller to detect the rotation of the spool. According to yet another aspect of the invention, the optical sensor is operable to detect the rotation of the spool while the spool abuts a surface of the handheld printer.

The handheld printer can also include at least one guide operable to direct the material under the at least one print nozzle. Furthermore, a second portion of the material is mounted on the spool. The material can include a ribbon, strip of fabric, or strip of paper.

According to another embodiment of the present invention, there is disclosed a method of printing. The method includes receiving a first portion of a material underneath at least one print nozzle, where at least a second portion of the material is mounted on a spool, detecting the rotation of the spool using an optical sensor, and instructing the at least one print nozzle to eject ink onto the first portion of the material based, at least in part, on the detection of the rotation of the spool using the optical sensor.

According to one aspect of the invention, the first portion of the material is directed underneath the at least one handheld printer print nozzle using at least one guide. According to another aspect of the invention, rotation of the spool is detected using a tracking roller coupled to the spool. The method may also include mounting the spool on a base, where the base that engages a printer having the at least one print nozzle. According to yet another aspect of the invention, instructing the at least one print nozzle to eject ink includes instructing the at least one print nozzle to eject ink onto the first portion of the material based, at least in part, on the speed of the rotation of the spool.

The method can also include identifying the size of the spool prior to detecting the rotation of the spool. The material can include a ribbon, strip of fabric, or strip of paper, and the method may further include receiving the first portion of the material on a take-up spool subsequent to the first portion of the material receiving ink. Additionally, the method can include rotating the take-up spool using at least one motor.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 shows a perspective view of a hand-held printer, according to an illustrative embodiment of the present invention

FIG. 2 shows a top view of a hand-held printer, according to an illustrative embodiment of the present invention.

FIG. 3 shows a top view of a printing system, according to an illustrative embodiment of the present invention.

FIG. 4 shows a side view of a printing system, according to another illustrative embodiment of the present invention.

FIG. 5 shows a top view of elements of a printing system, according to yet another illustrative embodiment of the present invention.

FIG. 6 shows a block diagram flow chart illustrating a method of the present invention, according to an illustrative example of the present invention.

### DETAILED DESCRIPTION OF THE INVENTION

The present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

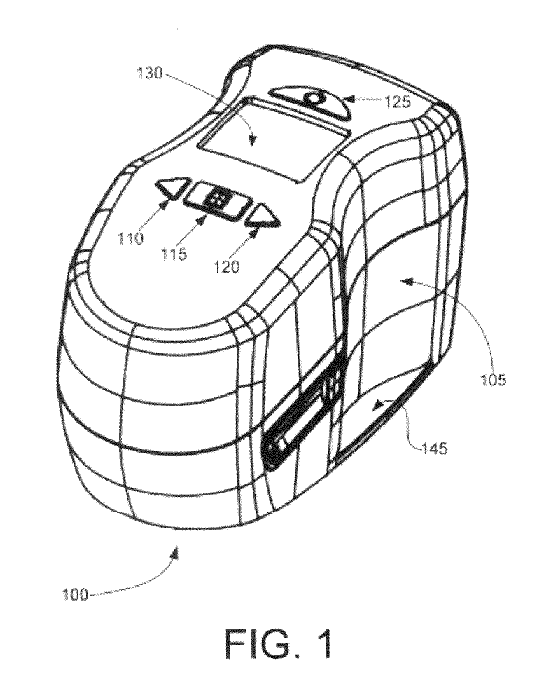

FIG. 1 shows a perspective view of a hand-held printer 100, according to an embodiment of the present invention. The hand-held printer 100 generally includes a housing 105 for enclosing printer components, a display screen 130, such as an LCD screen, and one or more buttons 110, 15, 120, 125 for controlling the operation of hand-held printer 100. To print the hand-held printer 100 also includes a printer head (not illustrated) that emits a marking substance, such as ink, onto a printing surface. Also included within the hand-held printer 100 is at least one internal tracking device (not illustrated) to identify the location of the hand-held printer 100, as is known in the art. The internal tracking device may include an optical mouse tracking device, or one or more rolling elements, to identify the current location of the hand-held printer 100, which may be in reference to an earlier location of the hand-held printer 100.

The hand-held printer 100 also includes one or more algorithms stored within a memory of the hand-held printer 100, which may be executed by the aid of a processor or like computing device to effect the printing processes described herein. Collectively the one or more algorithms and processor or other hardware for executing print instructions are referred to as the print management module (not illustrated). The print management module may also or alternatively include an application specific integrated circuit (ASIC) or the like to effect the processes described herein. The print management module can receive instructions from the internal tracking device and utilize those instructions to determine when to instruct the printer head to print.

According to one aspect of the invention, the one or more buttons 110, 115, 120, 125 are operative to enable a user to select and control one or more operations or functions of the hand-held printer 100. For instance, the buttons 110, 115, 120, 125 permit a user to select an image for printing, to print using the hand-held printer 100. According to one aspect of the invention, the one or more buttons 110, 115, 120, 125 may represent ‘soft’ buttons whose associated functions are displayed on the display 130. According to another aspect of the invention, the one or more buttons 110, 115, 120, 125 may be used to highlight and select functions displayed on the display 130. Although illustrated on a top side of the hand-held printer 100, it will be appreciated that the one or more buttons 110, 115, 120, 125 may be positioned anywhere on the housing 105 of the hand-held printer 100.

A user may initiate printing through the issuance of a command to the handheld printer 110. Such a command may come from the pressing of one or more buttons 110, 115, 120, 125, which may trigger the print head to begin printing an image. In alternate embodiments, print commands may come by way of voice commands or optical impulses. The handheld printer 100 may receive image data for printing from a number of sources. For instance, the handheld printer 100 may receive image data from a computer via a cable or wireless connection, such as via a USB cable or via Bluetooth®. The image data will be stored within a memory in the hand-held printer 100 for use in printing. According to another illustrative embodiment, a memory card containing image data, for instance, in an image file, may be inserted in to the handheld printer 100 and act as the local memory of the printer.

As illustrated in FIG. 1, the handheld printer 100 includes a display screen 130. According to an aspect of the invention, the display screen 130 may be operable to display a representation of the amount of the currently printing image that has been printed at any given point in time. According to another aspect of the invention, the user can view the image to be printed on the LCD screen, or may view a file name associated with the image. The display screen 130 may also alert the user that an image has been completely printed by the hand-held printer 100.

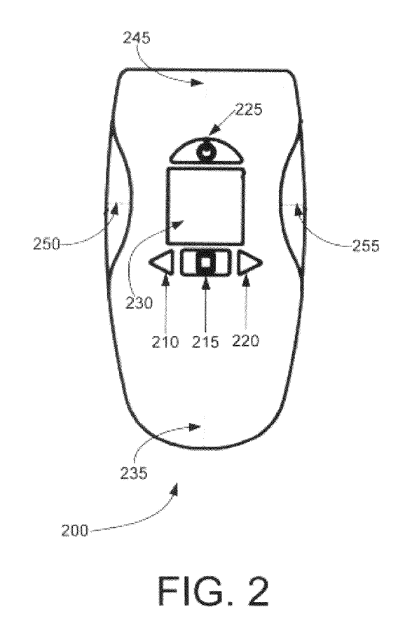

FIG. 2 shows a top view of a handheld printer 200, according to an illustrative embodiment of the present invention. According to an aspect of the invention, the hand-held printer 200 includes a display 230 and one or more buttons 210, 215, 220, 225 that operate in a similar manner, respectively, as the display 130 and one or more buttons 110, 115, 120, 125 described above with respect to FIG. 1. Although not shown in FIG. 2, the hand-held printer 200 also includes a printer head that emits a marking substance, such as ink, onto a printing surface to print an image, and at least one internal tracking device (not illustrated) to identify the location of the hand-held printer 200, as is known in the art

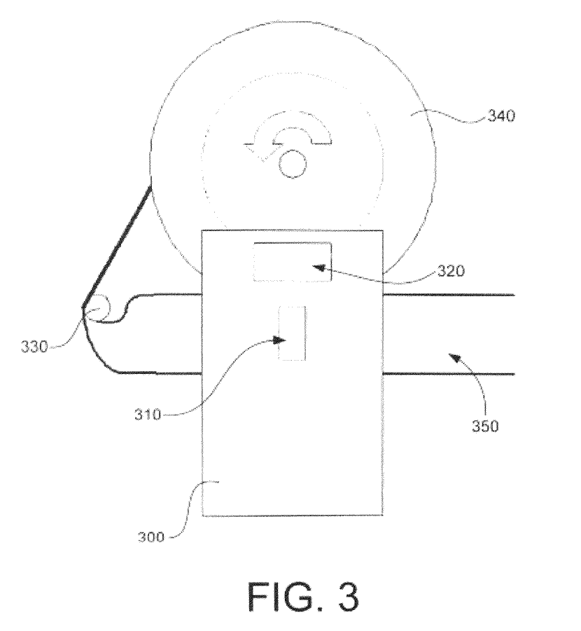

FIG. 3 shows a handheld printer 300 similar to those described above with respect to FIGS. 1 and 2. The handheld printer 300 engages a spool 340 that is operable to carry a material 350, such as a ribbon, strip of fabric, narrow paper, decorative paper, streamer, wallpaper border, or any other narrow media that may be printed upon. Specifically, the material is wound around the circular spool 340, which is operable to rotate in a counter-clockwise fashion.

According to one aspect of the invention, the spool 340 is mounted in a recess in a base, such as a plastic base, that also engages the handheld printer 300 so that the respective positions of the handheld printer 300 and spool 340 remained fixed with respect to each other. The base may be separate from the printer 300 and spool 340, or may be permanently integrated with either the spool 340 and/or printer 300. The spool 340 is mounted to enable rotation of the spool 340 as illustrated in FIG. 3. According to an illustrative embodiment of the invention, the spool 340 is biased upward by a bias spring such that it maintains contact with the underside of the handheld printer 300. The spool 340 may be free to rotate about a pin or similar element, but the bias spring supplies a small resistance force (or friction) to prevent the spool from freely spinning without an externally applied force, as described below. Additionally, the pin or similar element may be adjustable to permit different size spools to engage the printer 300.

The spool 340 is biased to maintain contact with the optical sensor 320 to permit the optical sensor 320 to collect data identifying movement of the spool 340 as it rotates. According to one aspect of the invention, the optical sensor 320 is placed on top of the spool 340. However, the print head and print head nozzles 310 inside the handheld printer 300 are located away from the spool 340. As shown in FIG. 3, the material 350 wound around the spool 340 passes by a guide 330 that rotates the surface of the material 350 by 90 degrees such that one of the two faces of the material will pass underneath the handheld printer 300, and more specifically, the print head nozzles 310. Although only a single guide 330 is illustrated, multiple guides may also be used. For instance, the material 350 may pass between two opposing guides. Additionally, guides in the base upon which the spool 340 is mounted may also position the material 350 underneath the print head nozzles 310.

To print on the material 350 the user can manually pull the ribbon past the print head nozzles 310 (from left to right in the illustrative embodiment of FIG. 3). Pulling of the material 350 overcomes the force exerted on the guide 340 by the bias spring, which as noted above, supplies a small resistance force (or friction) to otherwise prevent the spool 340 from freely spinning without a user's pulling of the material 350.

In operation, the optical sensor 320 detects the rotation of the spool. In particular, the optical sensor 320 works in conjunction with the print management module to identify rotation of the spool, which the print management module uses to determine whether to instruct the print head modules 310 to print onto the material 350, and the speed with which to print onto the material 350. The handheld printer 300 can print indefinitely until it runs out of ink or material 350 on which to print.

According to one aspect of the invention, the printer 300 instructs at least one print head nozzle 310 to eject ink onto a first portion of the material positioned under the at least one print head nozzle, with the remaining portion of the material wound on the spool 340 (or having already received print). The aforementioned base may include a spit cup directly underneath the print head nozzles 310 to catch excess ink ejected from the print head nozzles 310 if the material 350 is narrower than the print swath

It will be appreciated that the radius of the spool 340 can impact the speed with which the print management module instructs the print head nozzles 310 to eject ink onto the material to maintain accurate printing. According to one aspect of the invention, the spool may include a core that limits the range of radiuses of the material wound on the spool, which maintains a 1 to 1 ratio between the rotation detected by the optical sensor 320 and the actual motion of the material. This prevents the printed output from stretching or compressing. According to another aspect of the invention, the handheld printer 300 may also receive the radius of the spool 340 and/or an indication of the core size to identify whether a 1 to 1 ratio is maintained.

According to additional aspects of the invention, a cutting element (not illustrated) may be located at the end of the material's 350 feed path; i.e., at a location the material 350 passes subsequent to receiving ink from the print head nozzles 310. This may be integrates into the base or into the handheld printer 300. Additionally, an edge can be integrated into the base or printer to permit a user to create a curl by pulling the material 350 against the edge.

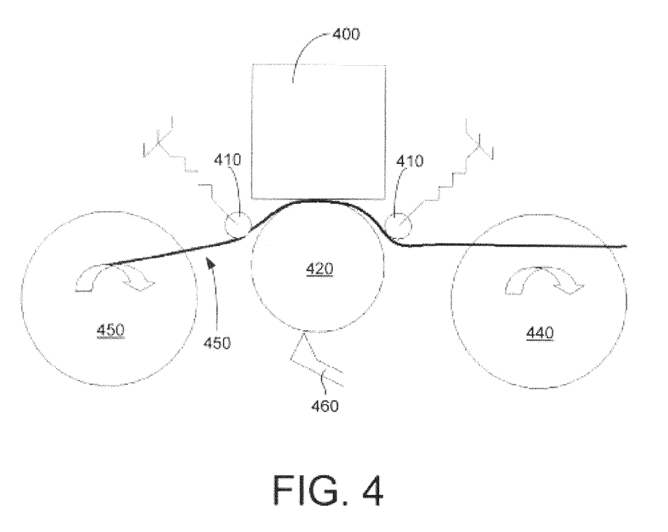

FIG. 4 illustrates another embodiment of the present invention. In this embodiment a narrow piece of material 450, such as a ribbon, the ribbon is held against a drum 420 that turns in a counter-clockwise fashion as the material 450 is pulled underneath print head nozzles (not illustrated) of the handheld printer 400. The handheld printer's optical sensor can view the surface of the drum or can read the surface of the ribbon to identify movement of the material 350, which as described above with respect to FIG. 3 is used to instruct the printer's print head nozzles to eject ink onto the material 450. According to one aspect of the invention, the optical sensor may view the surface of the drum 420 if the ribbon is narrow, such as approximately 1 inch in width or less, and can read the surface of the ribbon if it is wide, such as more than approximately 1 inch in width. The surface of drum 420, which rotates with the movement of the material 450, can be textured or knurled to ensure that its movement may be identified by the optical sensor.

In the illustrative embodiment of FIG. 4, an optional take-up spool 440 may exist in addition to the spool 450 to receive the material subsequent to it receiving print. Although the take-up spool 440 may be hand-cranked, the take-up spool 440 permits the print system shown in FIG. 4 to be motorized, such that the motorized rotation of the take-up spook 440 allows automated feeding of the material 450. Also shown in FIG. 4 are optional nip idlers 410 that prevent the material 450 from rubbing against the entire surface of the underside of the handheld printer 400, which may leave unwanted ink on a portion of the material 450. The optional nip idlers 410 may also be relocated near the bottom of the drum to impart greater frictional force between the ribbon and drum 420. Additionally, a wiper or drum cleaner 460 may be used to clean the drum of any ink to prevent unwanted ink from contacting the underside of the material 450. According to one aspect of the invention, any width of material 450 ranging from approximately ¼″ to 6″ inches in width can be printed using the present invention.

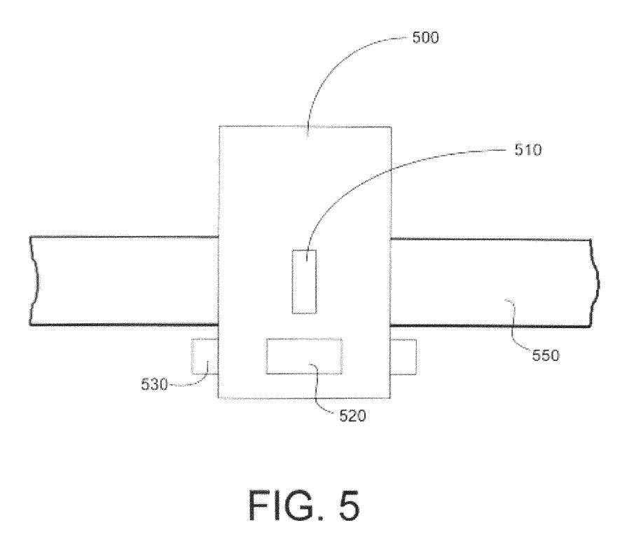

Another embodiment of a printing system of the present invention is shown in FIG. 5. In this embodiment a spool (not shown) is coupled to a tracking roller 530, which in turn is read by the optical sensor 520. According to an aspect of the invention, the tracking roller 530 may be geared to and driven by the spool. The gear ratio between the tracking roller and the spool may be adjusted to compress or stretch the printed image applied to the material 550 by the printer 500 and more specifically, the print head nozzles 510. It will be appreciated that this embodiment may be combined with either of the illustrative embodiments described above with respect to FIGS. 3 and 4.

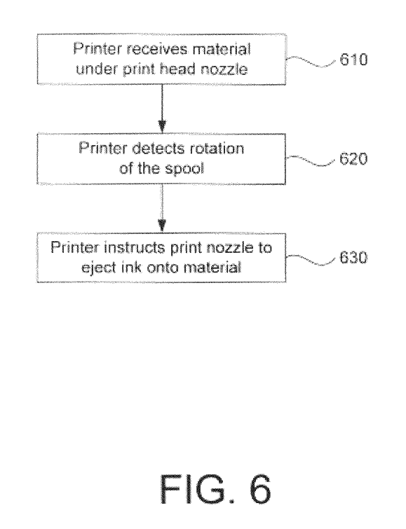

FIG. 6 shows a block diagram flow chart illustrating a method of the present invention, according to an illustrative example of the present invention. The printer receives a first portion of a material underneath at least one print head nozzle (block 610), where at least a second portion of the material is mounted on a spool. The printer detects the rotation of the spool using an optical sensor (block 620), and then instructs the at least one print nozzle to eject ink onto the first portion of the material based, at least in part, on the detection of the rotation of the spool using the optical sensor (block 630).

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A handheld printer, comprising:
at least one print nozzle;
an optical sensor, wherein the optical sensor is operable to detect the rotation of a spool engaging the handheld printer; and
at least one print management module, operable to instruct the at least one print nozzle to eject ink onto a first portion of a material responsive to the optical sensor detecting the rotation of the spool.

2. The handheld printer of claim 1, wherein the at least one print management module comprises a processor, an application specific integrated chip, or computer-executable program code.

3. The handheld printer of claim 1, further comprising a tracking roller coupled to the spool, wherein the optical sensor detects movement of the tracking roller to detect the rotation of the spool.

4. The handheld printer of claim 1, wherein the optical sensor is operable to detect the rotation of the spool while the spool abuts a surface of the handheld printer.

5. The handheld printer of claim 1, further comprising at least one guide operable to direct the material under the at least one print nozzle.

6. The handheld printer of claim 1, where a second portion of the material is mounted on the spool.

7. The handheld printer of claim 1, wherein the material comprises a ribbon, strip of fabric, or strip of paper.

8. A method of printing, comprising:
receiving a first portion of a material underneath at least one print nozzle, wherein at least a second portion of the material is mounted on a spool;
detecting the rotation of the spool; and
instructing the at least one print nozzle to eject ink onto the first portion of the material based, at least in part, on the detection of the rotation of the spool.

9. The method of claim 8, further comprising directing the first portion of the material underneath the at least one handheld printer print nozzle using at least one guide.

10. The method of claim 8, further comprising detecting the rotation of the spool using a tracking roller coupled to the spool.

11. The method of claim 8, further comprising mounting the spool on a base, wherein the base that engages a printer having the at least one print nozzle.

12. The method of claim 8, wherein instructing the at least one print nozzle to eject ink onto the first portion of the material based, at least in part, on the detection of the rotation of the spool comprises:
instructing the at least one print nozzle to eject ink onto the first portion of the material based, at least in part, on the speed of the rotation of the spool.

13. The method of claim 8, further comprising identifying the size of the spool prior to detecting the rotation of the spool.

14. The method of claim 8, wherein the material comprises a ribbon, strip of fabric, or strip of paper.

15. The method of claim 8, further comprising receiving the first portion of the material on a take-up spool subsequent to the first portion of the material receiving ink.

16. The method of claim 15, comprising rotating the take-up spool using at least one motor.
